(19) United States
(12) Patent Application Publication
(10) Pub. No.: US 2009/0083474 A1
(43) Pub. Date: Mar. 26, 2009

(54) FILE ALLOCATION TABLE MANAGEMENT

(76) Inventor: Thomas Cooke, Peyton, CO (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 11/859,449

(22) Filed: Sep. 21, 2007

(51) Int. Cl. G06F 12/00

(52) U.S. Cl. 711/103; 711/E12.001

(57) ABSTRACT

In one embodiment, a storage controller comprises a first port that provides an interface to a host computer, a second port that provides an interface a storage device, a processor, and a flash memory module communicatively connected to the processor and comprising logic instructions which, when executed by the processor, configure the processor to receive, in a file allocation table manager, a signal indicative of a request to perform a first update of a file allocation table stored in a memory module, locate, in the memory module, a first memory sector corresponding to a first entry in the file allocation table having an active status, write, in the memory module, a second file allocation table entry, set a status flag associated with the second entry to an active state, and set a status flag associated with the first entry to a standby state.

### BACKGROUND

The described subject matter relates to electronic computing, and more particularly to file allocation table (FAT) management.

Effective collection, management, and control of information have become a central component of modern business processes. To this end, many businesses implement computer-based information management systems. Data management is an important component of computer-based information management systems. Many users implement storage area networks (SANs), alone or in combination with network attached storage (NAS) devices to manage data operations in computer-based information management systems.

Storage area networks and network attached storage devices commonly include a plurality of storage media devices, e.g., disk drives. Information on the disk drives is accessed and managed by storage controllers, which may be implemented as removable cards. Many storage controllers are programmable and include one or more processors which may execute software (i.e., firmware) residing in a memory module on the storage controller and a file allocation table to manage the location of software in the memory module.

The software on the controller may be updated periodically for various reasons, thereby necessitating an update of the file allocation table.

### BRIEF DESCRIPTION OF THE DRAWINGS

The disclosed embodiments will be better understood from a reading of the following detailed description, taken in conjunction with the accompanying Figures in the drawings in which:

FIG. 1 is a schematic illustration of networked computing system that utilizes a storage network, according to embodiments.

FIG. 2 is a schematic illustration of a storage network, according to embodiments.

FIG. 3 is a schematic illustration of a storage cell architecture, according to embodiments.

FIG. 4 is a schematic illustration of an exemplary embodiment a memory architecture that may be implemented in a storage device.

FIG. 5 is a flowchart illustrating operations in a first embodiment of a method to manage a file allocation table.

### DETAILED DESCRIPTION

Described herein are exemplary system and methods to manage a file allocation table on a flash memory device. The methods described herein may be embodied as logic instructions on a computer-readable medium. When executed on a processor, the logic instructions cause the processor to be programmed as a special-purpose machine that implements the described methods. The processor, when configured by the logic instructions to execute the methods recited herein, constitutes structure for performing the described methods.

In some embodiments described herein, the file allocation table may be implemented in a controller such as a storage controller in a storage cell. However, the described embodiments are meant to be illustrative, not limiting. One skilled in the art will understand that in alternate embodiments, the file allocation table may be implemented on a network controller such as an Ethernet controller, a wireless network interface card, or the like.

In the following description, numerous specific details are set forth to provide a thorough understanding of various embodiments. However, it will be understood by those skilled in the art that the various embodiments may be practiced without the specific details. In other instances, well-known methods, procedures, components, and circuits have not been illustrated or described in detail so as not to obscure the particular embodiments.

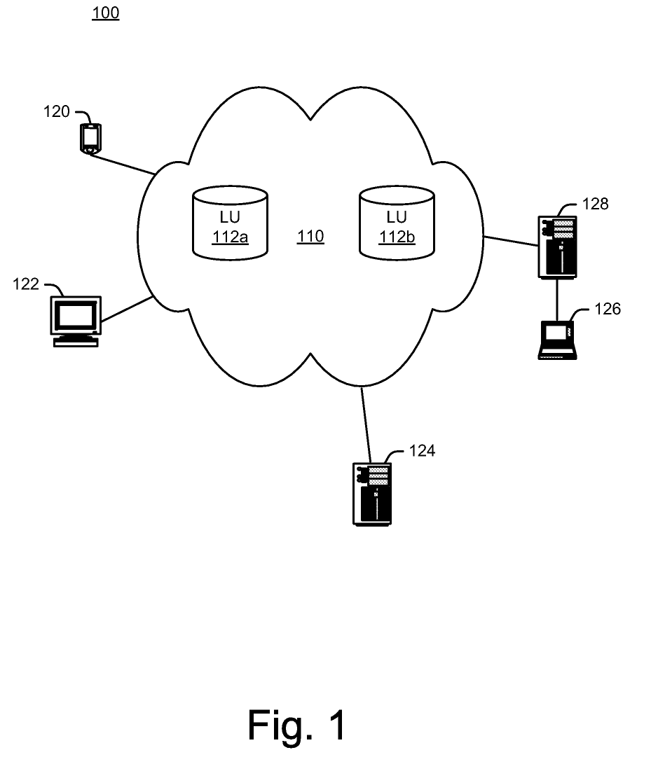

FIG. 1 is a schematic illustration of an exemplary embodiment of a networked computing system 100 that utilizes a storage network. The storage network comprises a storage pool 110, which comprises an arbitrarily large quantity of storage space. In practice, a storage pool 110 has a finite size limit determined by the particular hardware used to implement the storage pool 110. However, there are few theoretical limits to the storage space available in a storage pool 110.

A plurality of logical disks (also called logical units or LUs) 112a, 112b may be allocated within storage pool 110. Each LU 112a, 112b comprises a contiguous range of logical addresses that can be addressed by host devices 120, 122, 124 and 128 by mapping requests from the connection protocol used by the host device to the uniquely identified LU 112. As used herein, the term “host” comprises a computing system(s) that utilize storage on its own behalf, or on behalf of systems coupled to the host. For example, a host may be a supercomputer processing large databases or a transaction processing server maintaining transaction records. Alternatively, a host may be a file server on a local area network (LAN) or wide area network (WAN) that provides storage services for an enterprise. A file server may comprise one or more disk controllers and/or RAID controllers configured to manage multiple disk drives. A host connects to a storage network via a communication connection such as, e.g., a Fibre Channel (FC) connection.

A host such as server 128 may provide services to other computing or data processing systems or devices. For example, client computer 126 may access storage pool 110 via a host such as server 128. Server 128 may provide file services to client 126, and may provide other services such as transaction processing services, email services, etc. Hence, client device 126 may or may not directly use the storage consumed by host 128.

Devices such as wireless device 120, and computers 122, 124, which may also function as hosts, may logically couple directly to LUs 112a, 112b. Hosts 120-128 may couple to multiple LUs 112a, 112b, and LUs 112a, 112b may be shared among multiple hosts. Each of the devices shown in FIG. 1 may include memory, mass storage, and a degree of data processing capability sufficient to manage a network connection.

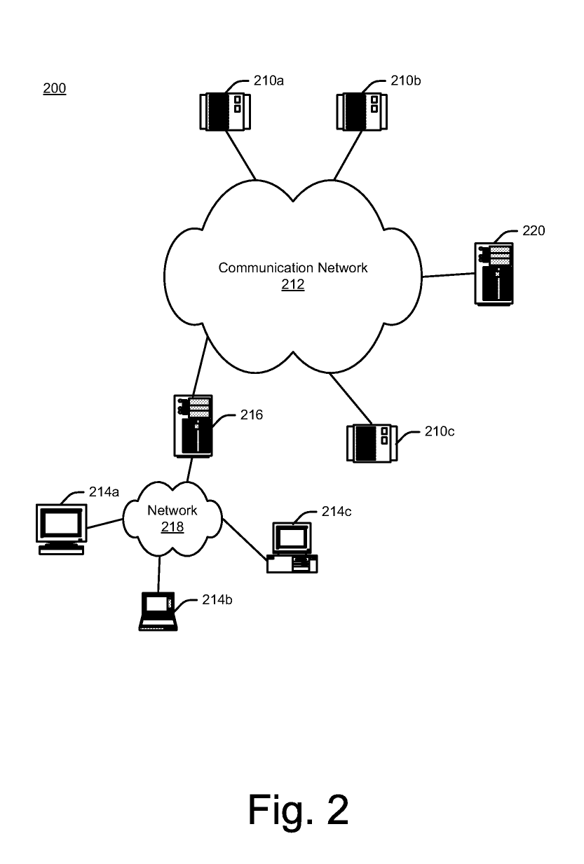

FIG. 2 is a schematic illustration of an exemplary storage network 200 that may be used to implement a storage pool such as storage pool 110. Storage network 200 comprises a plurality of storage cells 210a, 210b, 210c connected by a communication network 212. Storage cells 210a, 210b, 210c may be implemented as one or more communicatively connected storage devices. Exemplary storage devices include the STORAGEWORKS line of storage devices commercially available from Hewlett-Packard Corporation of Palo Alto, Calif., USA. Communication network 212 may be implemented as a private, dedicated network such as, e.g., a Fibre Channel (FC) switching fabric. Alternatively, portions of communication network 212 may be implemented using public communication networks pursuant to a suitable communication protocol such as, e.g., the Internet Small Computer Serial Interface (ISCSI) protocol.

Client computers 214a, 214b, 214c may access storage cells 210a, 210b, 210c through a host, such as servers 216, 220. Clients 214a, 214b, 214c may be connected to file server 216 directly, or via a network 218 such as a Local Area Network (LAN) or a Wide Area Network (WAN). The number of storage cells 210a, 210b, 210c that can be included in any storage network is limited primarily by the connectivity implemented in the communication network 212. In some embodiments a switching fabric comprising a single FC switch can interconnect 256 or more ports, providing a possibility of hundreds of storage cells 210a, 210b, 210c in a single storage network.

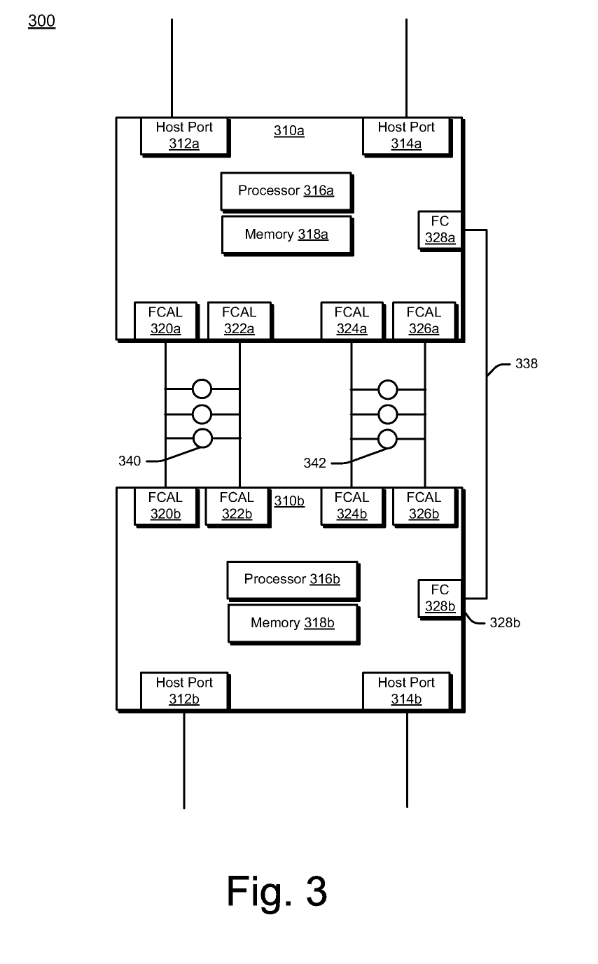

FIG. 3 is a schematic illustration of a storage cell architecture, according to embodiments. It will be appreciated that the storage cell 300 depicted in FIG. 3 is merely one exemplary embodiment, which is provided for purposes of explanation. The particular details of the storage cell 300 are not critical. Further, the architecture illustrated in FIG. 3 provides a fully-redundant storage cell. This redundancy is entirely optional. In practice, redundant components may be, and frequently are, omitted.

Referring to FIG. 3, storage cell 300 includes two Network Storage Controllers (NSCs) (also referred to as storage controllers or disk controllers) 310a, 310b to manage the operations and the transfer of data to and from one or more sets of disk drives 340, 342. NSCs 310a, 310b may be implemented as plug-in cards having a microprocessor 316a, 316b, and memory 318a, 318b. Each NSC 310a, 310b includes dual host adapter ports 312a, 314a, 312b, 314b that provide an interface to a host, i.e., through a communication network such as a switching fabric. In a Fibre Channel implementation, host adapter ports 312a, 312b, 314a, 314b may be implemented as FC N_Ports. Each host adapter port 312a, 312b, 314a, 314b manages the login and interface with a switching fabric, and is assigned a fabric-unique port ID in the login process. Each NSC 310a, 310b further includes a communication port 328a, 328b that enables a communication connection 338 between the NSCs 310a, 310b. The communication connection 338 may be implemented as a FC point-to-point connection, or pursuant to any other suitable communication protocol.

In an exemplary implementation, NSCs 310a, 310b further include a plurality of Fiber Channel Arbitrated Loop (FCAL) ports 320a-326a, 320b-326b that implements an FCAL communication connection with a plurality of storage devices, e.g., sets of disk drives 340, 342. While the illustrated embodiment implement FCAL connections with the sets of disk drives 340, 342, it will be understood that the communication connection with sets of disk drives 340, 342 may be implemented using other communication protocols. For example, rather than an FCAL configuration, a FC switching fabric may be used.

In operation, the storage capacity provided by the sets of disk drives 340, 342 may be added to the storage pool 110. When an application requires storage capacity, logic instructions on a host computer 128 establish a LU from storage capacity available on the sets of disk drives 340, 342 available in one or more storage sites. It will be appreciated that, because a LU is a logical unit, not a physical unit, the physical storage space that constitutes the LU may be distributed across multiple storage cells. Data for the application is stored on one or more LUs in the storage network. An application that needs to access the data queries a host computer, which retrieves the data from the LU and forwards the data to the application.

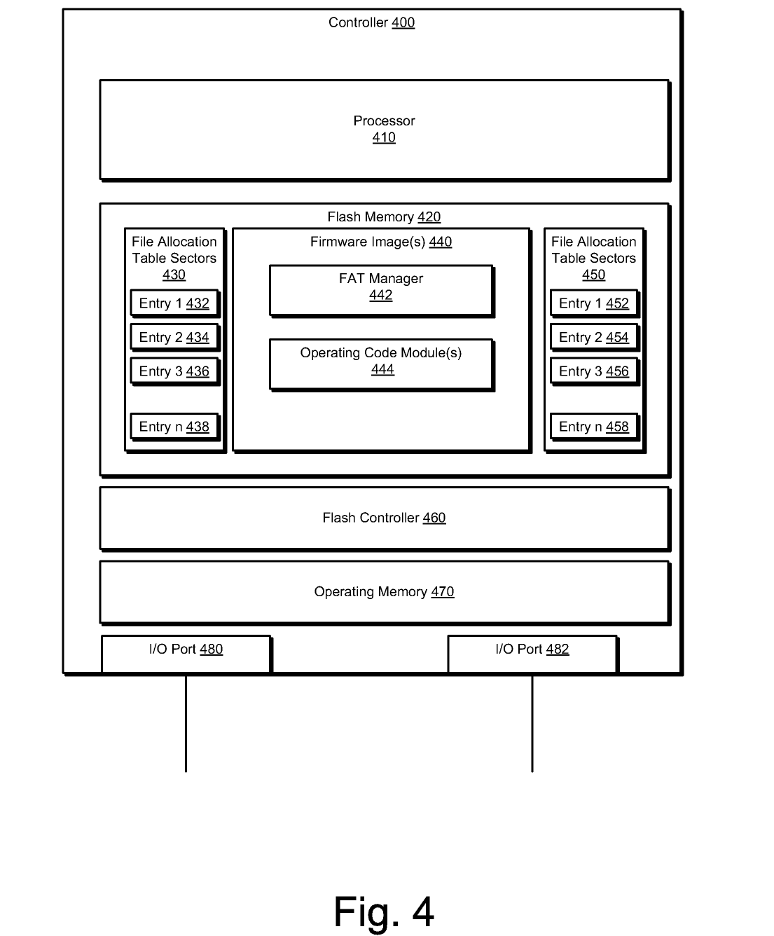

FIG. 4 is a schematic illustration of an exemplary embodiment a memory architecture that may be implemented in a storage device. In some embodiments, the controller 400 depicted in FIG. 4 may correspond to do one of the network storage controllers 310a, 310b depicted in FIG. 3. Referring to FIG. 4, in some embodiments the control of 400 comprises a processor 410, a flash memory module 420, a flash controller 460 an operating memory module 470, and one or more input/output ports 480, 482.

As used herein, the term “processor” refers to any type of computational element, such as but not limited to, a microprocessor, a microcontroller, a complex instruction set computing (CISC) microprocessor, a reduced instruction set (RISC) microprocessor, a very long instruction word (VLIW) microprocessor, or any other type of processor or processing circuit.

Volatile memory module 470 may be implemented as any type of computer-readable memory such as random access memory (RAM), non-volatile RAM (NV-RAM), dynamic RAM (DRAM), magnetic memory, optical memory, read only memory (ROM), or combinations thereof. In some embodiments, operating memory 460 may be implemented as high-speed, volatile DRAM.

In some embodiments, input/output port 480 provides an interface to a host computer, while input/output port 482 provides an interface to one or more storage devices.

In some embodiments, flash memory 420 may be implemented as a conventional flash memory chip, alone or in combination with a flash controller 460. In one embodiment, flash memory may be implemented as a 32 MB flash chip, which is logically divided into 64K sectors. In another embodiment, the control 400 may comprise two or more flash memory devices 420, each of which may be implemented as a 32 MB device, divided into 64K sectors.

In some embodiments, the flash memory 420 comprises a first set of sectors which are reserved to store a first file allocation table 430, a second set of sectors which are reserved to store a second file allocation table 450, and a third region which stores one or more firmware images 440. The second file allocation table 450 is provided for redundancy purposes and may be omitted.

In some embodiments, the flash memory module 420 may be used to store firmware that manages the operations of the controller 400. Thus, the firmware images 440 may include one or more operating code modules 444 to manage the operations of controller 400. In operation, when the controller 400 is booted the firmware images from the flash memory 420 are copied to operating memory 470 where they can be executed by the processor 410 to manage the operations of the controller 400. In addition, the firmware images 440 include a file allocation table manager 442 which comprises logic instructions to manage file allocation table sectors 430, 450, for example when the firmware images 440 in the flash memory are updated.

In some embodiments, the first file allocation table 430 and the second file allocation table 450 are stored in two contiguous sectors of memory. This enables multiple file allocation table to be stored on each sector and permits an entire sector to be erased while maintaining valid data in the other sector. File allocation table entries are written from the lowest address space upward and in a circular manner. File allocation table entries are not permitted to cross sector boundaries, and table structures may be padded as necessary to ensure this.

As mentioned previously, the file allocation table sectors 430, 450 are redundant. In the interest of brevity, this document will describe the file allocation table structure and operations with reference to file allocation table sectors 430. One skilled in the art will recognize that file allocation table sectors 450 may implement corresponding structure and operations.

In some embodiments, the file allocation table sector 430 provides adequate storage capacity such that the sectors can include a plurality of file allocation table entries 432, 434, 436, 438. Each file allocation table entry maps all sectors of the firmware images 440 which includes all files downloaded and prior files not overwritten. For example, when firmware is updated the updates to the firmware are written as a single file allocation table entry to the flash memory module (or as two entries in an embodiment that includes a redundant file allocation table).

In some embodiments, each file allocation table entry includes a pointer to the location in memory at which each firmware image type starts. In one embodiment, firmware images occupy contiguous sectors from the starting sector. File allocation table entries further include one or more sector flags which indicate which image type occupies the flash sector, one or more usage flags for each file type, and a compatibility number for each image type.

Further, each file allocation table entry includes a code (e.g., a cyclical redundancy code (CRC)) embedded to indicate a status associated with the entry. In some embodiments, the file allocation table entry may be in one of several states. For example, in an “available” state the data in the entry matches the erased value. In a “partial” the entry is being updated. In an “active” state the entry is associated with the current firmware image. In a “standby” state the entry was previously active, but now represents a prior level of code. Several standby states may be implemented to catalog multiple prior versions of firmware code. In an inactive state the entry is pending erase.

In some embodiments the flash memory will allow successive write operations to a single location if the write operation turns off bits that are currently set (i.e., changes the bit from a binary “1” value to a binary “0” value). By contrast, the flash memory will not allow write operations which turn on bits that are currently set off (i.e., changes the bit from a binary “0” value to a binary “1” value). Thus, in some embodiments the codes may be assigned values such that some state changes may be implemented by write operations, while other state changes require the sector to be erased to implement a state change.

In one embodiment, the system implements the following status codes and values:

| SCMI_FAT_AVAILABLE = | 0xFFFFFFFF |
|---|---|
| SCMI_FAT_PARTIAL = | 0xFFFF7FFF |
| SCMI_FAT_ACTIVE = | 0xFFFF3FFF |
| SCMI_FAT_STANDBY0 = | 0x7FFF1FFF |
| SCMI_FAT_STANDBY1 = | 0x3FFF1FFF |
| SCMI_FAT_STANDBY2 = | 0x1FFF1FFF |
| SCMI_FAT_STANDBY3 = | 0x0FFF1FFF |
| SCMI_FAT_STANDBY4 = | 0x07FF1FFF |
| SCMI_FAT_STANDBY5 = | 0x03FF1FFF |
| SCMI_FAT_INACTIVE = | 0 |

In some embodiments, the file allocation table manager 442 comprises logic instructions which, when executed by a processor such as, for example processor 410, or flash controller 460, configure the processor to manage the file allocation table 430 (or tables 430, 450), for example when one or more firmware images 440 are updated on the flash memory 420.

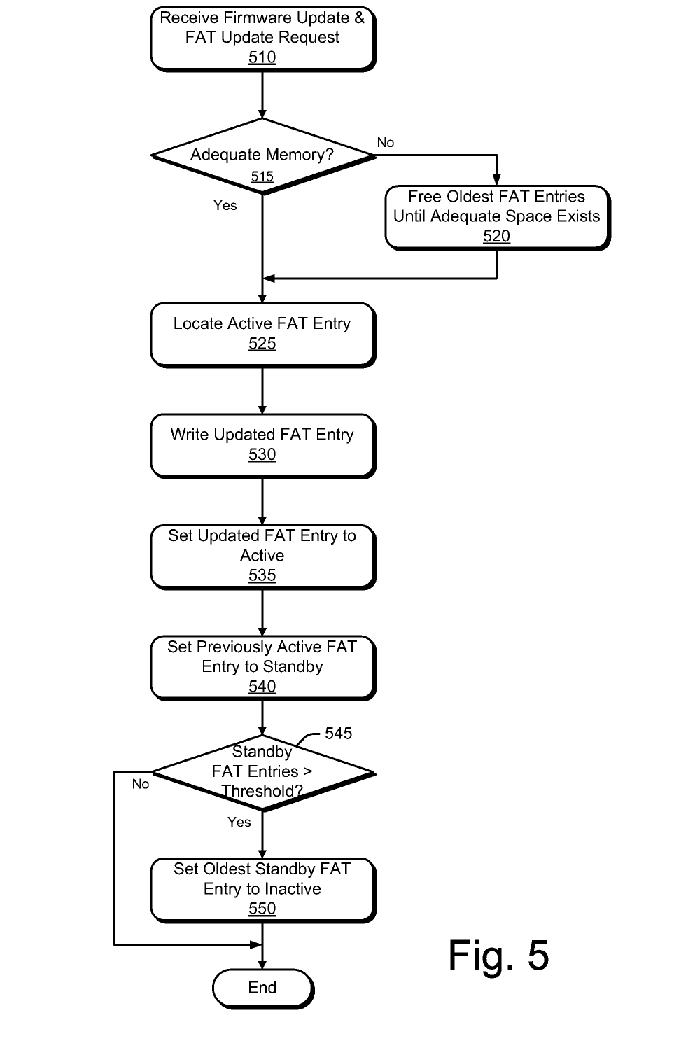

FIG. 5 is a flowchart illustrating operations in a first embodiment of a method to manage a file allocation table. Referring to FIG. 5, at operation 510, a firmware update and file allocation table update requests are received. In one embodiment, one more firmware images 440 such as, for example, one of the operating code modules 444 may be updated by flashing new code onto the flash memory 420. In response to the firmware update a request to update the file allocation table may be initiated, for example by the flash controller 460.

If, at operation 515, there is insufficient memory available to store the firmware images, then control passes to operation 520 and the oldest entry (or entries) are freed until there is sufficient space to hold the new firmware images.

At operation 525 the active entry in the file allocation table 430 is located. For example, the file allocation table may be searched to locate the entry for which the status code is set to an active state. At operation 530 an updated file allocation table entry is written into the memory sector 430. In some embodiments, the updated file allocation table entry is written in the next available memory location in the memory sector 430. While the entry is being written in memory the status of the updated file allocation table entry is set to “partial.”

After the updated file allocation table entry is written state changes are entered for the various entries in the file allocation table 430. Thus, at operation 535 the updated file in a location table entry has its status set to active. At operation 540 the previously active file allocation table entry as its status reset to “standby.” As described above, in some embodiments there may be multiple standby states to catalog multiple iterations of file allocation table entries. In such embodiments, the standby status of the previous file allocation table entries are reset. For example, an entry that was “standby1” may be reset to “standby2,” while the entry that was “standby2” may be reset to “standby3” and so on.

If, at operation 545, the number of standby file allocation table entries exceeds the number of available standby states, then the oldest file allocation table entry in standby state as its status changed to inactive at operation 550.

Thus, the structure depicted in FIG. 4 and the operations depicted in FIG. 5 permit a file allocation table associated with a flash memory device to be updated in response to updates to firmware stored on the flash memory device. New file allocation table entries may be created and updated without destroying current file allocation table entries, and the number of erase operations which must be performed on the file allocation table memory sectors is reduced significantly. Further, file allocation table entries are maintained for previous firmware images and are associated with state information pertaining to those images. Therefore, in the event of a failure occurs it may be possible to restore operations of the controller using a previous file allocation table.

Reference in the specification to “one embodiment” or “an embodiment” means that a particular feature, structure, or characteristic described in connection with the embodiment is included in at least an implementation. The appearances of the phrase “in one embodiment” in various places in the specification are not necessarily all referring to the same embodiment.

Thus, although embodiments have been described in language specific to structural features and/or methodological acts, it is to be understood that claimed subject matter may not be limited to the specific features or acts described. Rather, the specific features and acts are disclosed as sample forms of implementing the claimed subject matter.

What is claimed is:

1. A method to manage a file allocation table on a flash memory device, comprising:
receiving, in a file allocation table manager, a signal indicative of a request to perform a first update of a file allocation table stored in a memory module;
locating, in the memory module, a first memory sector corresponding to a first entry in the file allocation table having an active status;
writing, in the memory module, a second file allocation table entry;
setting a status flag associated with the second entry to an active state; and
setting a status flag associated with the first entry to a standby state.

2. The method of claim 1, wherein receiving, in a file allocation table manager, a signal indicative of a request to perform a first update of a file allocation table stored in a memory module comprises receiving an update to one or more firmware images in the flash memory device.

3. The method of claim 2, further comprising:
writing the update to one or more firmware images; and
setting the status flag associated with the second entry to a partial state while the firmware image is being written.

4. The method of claim 1, wherein locating, in the memory module, a first memory sector corresponding to at least a first entry and having an active status comprises searching one or more file allocation table sectors for a CRC value that is associated with an active state.

5. The method of claim 1, wherein setting a status flag associated with the first entry to a standby state comprises changing a bit in the status flag from a binary 1 value to a binary 0 value.

6. The method of claim 1, further comprising:
receiving, in a file allocation table manager, a signal indicative of a request to perform a second update of a file allocation table stored in a memory module; and
locating, in the memory module, a memory sector corresponding to a second entry in the file allocation table having an active status;
writing, in the memory module, a third file allocation table entry;
setting a status flag associated with the third entry to an active state; and
setting a status flag associated with the second entry to a standby state.

7. The method of claim 6, further comprising setting a status flag associated with an entry in the file allocation table to an inactive state.

8. A storage controller, comprising:
a first port that provides an interface to a host computer;
a second port that provides an interface a storage device;
a processor; and
a flash memory module communicatively connected to the processor and comprising logic instructions which, when executed by the processor, configure the processor to:
receive, in a file allocation table manager, a signal indicative of a request to perform a first update of a file allocation table stored in a memory module;
locate, in the memory module, a first memory sector corresponding to a first entry in the file allocation table having an active status;
write, in the memory module, a second file allocation table entry;
set a status flag associated with the second entry to an active state; and
set a status flag associated with the first entry to a standby state.

9. The storage controller of claim 8, the request to perform a first update of a file allocation table stored in a memory module comprises an update to one or more firmware images in the flash memory device.

10. The storage controller of claim 9, further comprising logic instructions stored on a computer readable medium which, when executed by the processor, configure the processor to:
write the update to one or more firmware images; and
set the status flag associated with the second entry to a partial state while the firmware image is being written.

11. The storage controller of claim 8, further comprising logic instructions stored on a computer readable medium which, when executed by the processor, configure the processor to searching one or more file allocation table sectors for a CRC value that is associated with an active state.

12. The storage controller of claim 8, further comprising logic instructions stored on a computer readable medium which, when executed by the processor, configure the processor to set a status flag associated with the first entry to a standby state by changing a bit in the status flag from a binary 1 value to a binary 0 value.

13. The storage controller of claim 8, further comprising logic instructions stored on a computer readable medium which, when executed by the processor, configure the processor to:
receive, in a file allocation table manager, a signal indicative of a request to perform a second update of a file allocation table stored in a memory module; and
locate, in the memory module, a memory sector corresponding to a second entry in the file allocation table having an active status;
write, in the memory module, a third file allocation table entry;
set a status flag associated with the third entry to an active state; and
set a status flag associated with the second entry to a standby state.

14. The storage controller of claim 13, further comprising setting a status flag associated with an entry in the file allocation table to an inactive state.

15. A computer program product comprising logic instructions stored in a computer readable medium which, when executed by a processor, configure the processor to update a file allocation table in a flash memory module by performing operations, comprising:
receiving, in a file allocation table manager, a signal indicative of a request to perform a first update of a file allocation table stored in the flash memory module;
locating, in the flash memory module, a first memory sector corresponding to a first entry in the file allocation table having an active status;
writing, in the flash memory module, a second file allocation table entry;
setting a status flag associated with the second entry to an active state; and
setting a status flag associated with the first entry to a standby state.

16. The computer program product of claim 15, wherein receiving, in a file allocation table manager, a signal indicative of a request to perform a first update of a file allocation table stored in a memory module comprises receiving an update to one or more firmware images in the flash memory device.

17. The computer program product of claim 16, further comprising logic instructions stored in a computer readable medium which, when executed by a processor, configure the processor to:
write the update to one or more firmware images; and
set the status flag associated with the second entry to a partial state while the firmware image is being written.

18. The computer program product of claim 15, further comprising logic instructions stored in a computer readable medium which, when executed by a processor, configure the processor to searching one or more file allocation table sectors for a CRC value that is associated with an active state.

19. The computer program product of claim 15, further comprising logic instructions stored in a computer readable medium which, when executed by a processor, configure the processor to:
receive, in a file allocation table manager, a signal indicative of a request to perform a second update of a file allocation table stored in a memory module; and
locate, in the memory module, a memory sector corresponding to a second entry in the file allocation table having an active status;
write, in the memory module, a third file allocation table entry;
set a status flag associated with the third entry to an active state; and
set a status flag associated with the second entry to a standby state.

20. The computer program product of claim 19, further comprising logic instructions stored in a computer readable medium which, when executed by a processor, configure the processor to set a status flag associated with an entry in the file allocation table to an inactive state.
